(19) United States
(12) Patent Application Publication
(10) Pub. No.: US 2017/0123753 A1
(43) Pub. Date: May 4, 2017

(54) ELECTRONIC DEVICE AND METHOD FOR PLAYING BACK SOUND DATA

(71) Applicant: Chiun Mai Communication Systems, Inc., New Taipei (TW)

(72) Inventor: YU-CHUN CHEN, New Taipei (TW)

(21) Appl. No.: 15/297,143

(22) Filed: Oct. 19, 2016

(30) Foreign Application Priority Data
Nov. 2, 2015 (CN) 201510732297.5

(51) Int. Cl. G06F 3/16; G11B 20/10

(52) U.S. Cl. CPC G06F 3/165; G11B 20/10527; G11B 2020/10546

(57) ABSTRACT

A method for playing back sound information in an electronic device includes setting a first trigger condition for starting a recording function, and the data which records sound is stored into an attached storage device. When a predetermined operation is detected, the sound data pertaining to a predetermined or selected time period is extracted and stored. Through the method the electronic device can play back the extracted sound data.

### CROSS-REFERENCE TO RELATED APPLICATIONS

This application claims priority to Chinese Patent Application No. 201510732297.5 filed on Nov. 2, 2015, the contents of which are incorporated by reference herein.

### FIELD

The subject matter herein generally relates to sound recording, and particularly to an electronic device and a method for playing back sound data using the electronic device.

### BACKGROUND

Electronic devices, such as mobile phones, are increasingly equipped with recording function. For example, when a user needs to record sound information during a phone call, the user can press a recording function button of the electronic device to record the sound information. Finding a particular part of the recorded sound information is not convenient.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 and FIG. 2 are block diagrams of one embodiment of an electronic device.

FIG. 3 is a block diagram of one embodiment of modules of a playing back system of the electronic device of FIG. 1.

FIG. 4 illustrates a flowchart of one embodiment of a method for playing back sound data recorded by the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

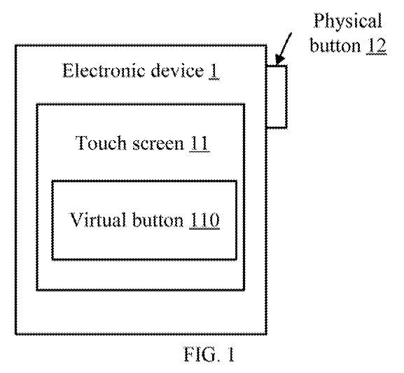

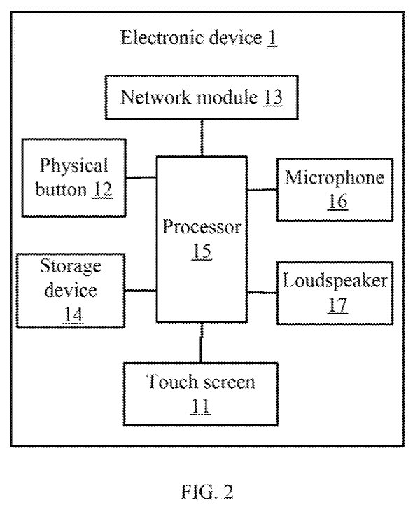

FIG. 1 and FIG. 2 are block diagrams of one embodiment of an electronic device. Depending on the embodiment, the electronic device 1 can include, but is not limited to, a touch screen 11, a physical button 12, a network module 13, a storage device 14, at least one processor 15, a microphone 16, and a loudspeaker 17. The above components communicate with each other through a system bus. In at least one embodiment, the electronic device 1 can be a mobile phone, a tablet computer, a personal digital assistant, or any other suitable device configured with a function of recording sound. FIG. 1 illustrates only one example of the electronic device 1 that can include more or fewer components than illustrated, or have a different configuration of the various components in other embodiments.

In at least one embodiment, the touch screen 11 can be a liquid crystal display (LCD) or an organic light-emitting diode (OLED) display screen. The touch screen 11 can detect touch events on one or more positions of the touch screen 11. The touch events include the user touching the touch screen 11, a contact position generated by the touch on the touch screen 11, and whether the touch on the touch screen 11 is moving or stationary. The touch screen 11 can display a number of predetermined time periods for the user to select, and can display a virtual button 110 of the electronic device 1.

In at least one embodiment, the physical button 12 can be a power button, a volume button, or a home key of the electronic device 1.

In at least one embodiment, the electronic device 1 can communicate with other electronic devices and can transmit data to the other electronic devices through the network module 13. The network module 13 can include, but is not limited to, any wired network, or wireless network, or both. The wired network can be any category of wired communication system, for example, the Internet or a local area network (LAN). The wireless network can be any category of wireless communication system, for example, General Packet Radio Service (GPRS), WIFI, Wideband Code Division Multiple Access (WCDMA), and High Speed Downlink Packages Access (HSDPA).

In at least one embodiment, the storage device 14 can be a memory of the electronic device 1. In other embodiments, the storage device 14 can be a secure digital card, or other external storage device such as a smart media card. In at least one embodiment, the storage device 11 can store a playing back system 10 and other applications. The playing back system 10 can record sound as data automatically when the user is in a conversation, and can extract data representing the sound recorded in a predetermined time period according to a selection input by the user.

The at least one processor 15 can be a central processing unit (CPU), a microprocessor, or other data processor chip that performs functions of the electronic device 1.

The microphone 16 can collect sound. The loudspeaker 17 can play back the sound.

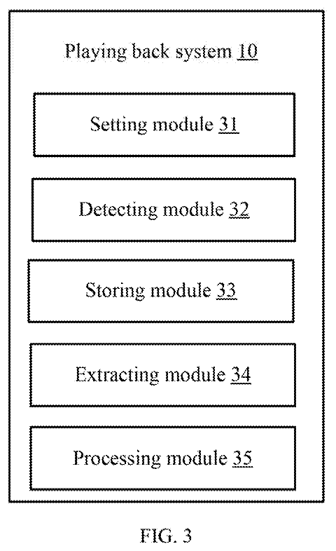

FIG. 3 is a block diagram of one embodiment of modules of a playing back system of the electronic device 1. In at least one embodiment, the playing back system 10 can include a setting module 31, a detecting module 32, a storing module 33, an extracting module 34, and a processing module 35. The modules 31-35 include computerized codes in the form of one or more programs that may be stored in the storage device 14. The computerized codes include instructions that are executed by the at least one processor 15.

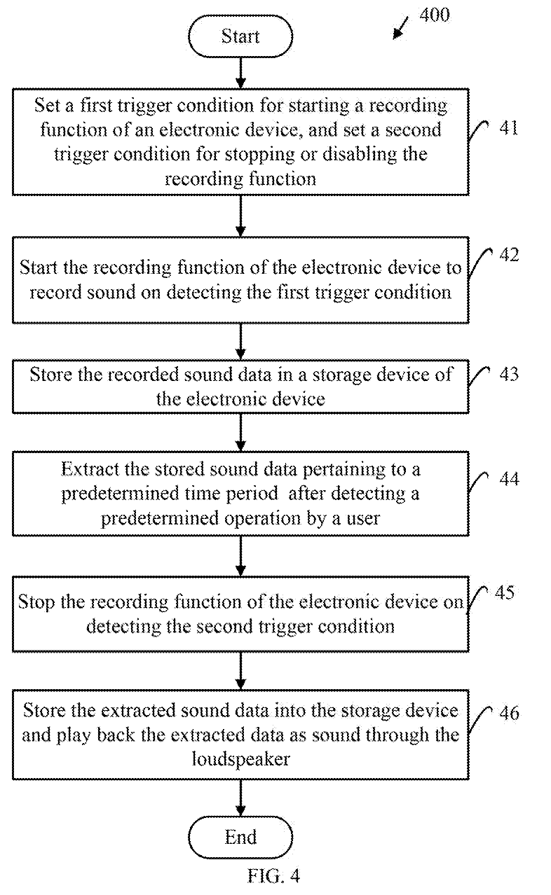

FIG. 4 illustrates a flowchart which is presented in accordance with an example embodiment. The example method 400 is provided by way of example, as there are a variety of ways to carry out the method. The method 400 described below can be carried out using the configurations illustrated in FIG. 1, for example, and various elements of these figures are referenced in explaining example method 400. Each block shown in FIG. 4 represents one or more processes, methods, or subroutines, carried out in the example method 400. Additionally, the illustrated order of blocks is by example only and the order of the blocks can be changed according to the present disclosure. The example method 400 can begin at block 41. Depending on the embodiment, additional steps can be added, others removed, and the ordering of the steps can be changed.

At block 41, the setting module 31 can set a first trigger condition for starting a recording function of the electronic device 1, and set a second trigger condition for stopping or disabling the recording function. In at least one embodiment, the first trigger condition includes, but is not limited to, establishing a conversation connection, turning on a music playback function, turning on a broadcast function, receiving a predetermined word or phrase, or opening a predetermined application of the electronic device 1. The conversation connection can be a mobile or a landline telephone call or can be a network-based telephone call. The network-based telephone call can be established by chat software, for example, QQ, Skype, Hangout, and others. In at least one embodiment, the predetermined application can include a meeting program, a scheduling program, and a notebook program. The second trigger condition includes disconnecting a conversation connection, turning off a music playback function, turning off a broadcast function, closing a predetermined application of the electronic device 1, or not receiving a predetermined word or phrase during a predetermined duration.

At block 42, the detecting module 32 can start the recording function of the electronic device 1 to record sound on detecting the first trigger condition. In at least one embodiment, the microphone 16 can receive sound as data when the electronic device 1 is recording sound.

In at least one embodiment, the detecting module 32 can start the recording function of the electronic device 1 to record sound on detecting a sound connection between the user and particular other person (e.g., a boss or other important person). The detecting module 32 can start the recording function of the electronic device 1 to record sound on detecting a predetermined word (e.g., discuss). The detecting module 32 can start the recording function of the electronic device 1 to record sound on detecting activation of a sound application.

At block 43, the storing module 33 can store the recorded sound as data in the storage device 14.

In at least one embodiment, the storing module 32 further can set one or more time periods of the recording or recordings. For example, when the user attends a seminar, to avoid too much storage capacity being dedicated to sound during the seminar, the storing module 32 can set the time period (e.g., two hours) for the recording.

At block 44, the extracting module 33 can extract the stored sound data pertaining to a predetermined time period from the storage device 14 after detecting a predetermined operation by the user. In at least one embodiment, the touch screen 11 can display a number of predetermined time periods for the user to select after the extracting module 34 detecting the predetermined operation. For example, the touch screen 11 can display ten minutes or twenty minutes for the user to select. Furthermore, the touch screen 11 can supply a user interface for the user to input some other predetermined time period.

In at least one embodiment, the predetermined operation includes, but is not limited to, pressing the physical button 12, clicking the virtual button 110, activating the touch screen 11 (e.g., double clicking on the touch screen 11), or shaking the electronic device 1. In at least one embodiment, the electronic device 1 further includes an accelerometer which can detect a shaking of the electronic device 1.

At block 45, the detecting module 32 can stop the recording function of the electronic device 1 on detecting the second trigger condition. For example, when the detecting module 11 detects the conversation is disconnected, the recording function of the electronic device 1 is stopped. When the detecting module 11 detects that the music player is turned off, the recording function of the electronic device 1 is stopped. When the detecting module 11 detects that the broadcast is turned off, the recording function of the electronic device 1 is stopped. When the detecting module 11 detects the closing or exit from the predetermined application, the recording function of the electronic device 1 is stopped. When a predetermined word is not received by the electronic device 1 during a predetermined duration, the recording function of the electronic device 1 is stopped.

At block 46, the processing module 35 can store the extracted sound data into the storage device 14 and can play back the extracted data as sound through the loudspeaker 17. In at least one embodiment, the processing module 35 further can delete the extracted sound data. The processing module 35 can provide a user interface on the touch screen 11 for the user to select to store or delete the extracted sound data. When the user selects storing the extracted sound data, the processing module 35 can store the extracted sound data into the storage device 14. When the user selects deleting the extracted sound data, the processing module 35 can delete the extracted sound data accordingly.

In at least one embodiment, the processing module 35 can upload the extracted sound data to internet, or search for relevant information of the extracted sound data on the network. For example, when the extracting module 34 extracts a piece of music from a broadcast application of the electronic device 1, the processing module 35 can provide a virtual button for “send” and a virtual button for “search” on the touch screen 11. When the user clicks “send”, the processing module 35 can upload the piece of music to website on internet. When the user clicks the virtual button “search”, the processing module 35 can search for a singer or a song name or an album name relevant to the piece of music on internet.

In at least one embodiment, blocks 41 and 42 can be omitted. In other embodiments, the playing back system 10 can record sound without detecting the first trigger condition, and store the recorded sound as data into the storage device 14. The playing back system 10 can extract data of the sound for the predetermined time period from the recorded sound data on detecting the predetermined operation, or can store the recorded sound into the storage device 14. The playing back system 10 further can delete the data as to sound recordings upon a schedule when there is no predetermined operation detected.

In one embodiment, when the user establishes a conversation connection with the particular other person using the electronic device 1, the detecting module 32 can start a recording function of the electronic device 1 to record sound data. The storing module 33 can store the recorded sound data into the storage device 14. When the user needs to record the conversation, the user can press the physical button 12 (e.g., a power button) to trigger the extracting module 34. The touch screen 11 can display a number of predetermined time periods for the user to select. The extracting module 34 can extract a predetermined time period (e.g., ten minutes) of sound data up to the current time, and store the extracted sound data into the storage device 14. Furthermore, the detecting module 32 can stop the recording function when the conversation is disconnected, and the processing module 35 can delete another or all other sound recordings except for the extracted sound, to save memory.

In one embodiment, when the user attends a seminar or a class or a meeting, the detecting module 32 can start the recording function of the electronic device 1 on receiving a predetermined word or opening a predetermined application. The storing module 33 can pre-set a time period for recording sound, for example, a period of two hours. The storing module 33 further can store the recorded sound data into the storage device 14. When the sound data is considered very important, the user can press the physical button 12 (e.g., a power button) to trigger the extracting module 34. The touch screen 11 can display a number of predetermined time periods for the user to select. The extracting module 34 can extract sound data for the predetermined time period (e.g., five minutes) before the current time, and store the extracted sound data into the storage device 14. Furthermore, the detecting module 32 can disable the recording function when the conversation is disconnected, and the processing module 35 can delete another or all other sound recordings except for the extracted sound data, to save memory.

In other embodiments, the playing back system 10 can play back the recorded sound data relating to the predetermined time period when the use is listening to a radio. The playing back system 10 can play back the recorded sound data with the predetermined time period when the user establishes a conversation connection through an application of the electronic device 1.

In other embodiments, a setting module 31, a detecting module 32, a storing module 33, an extracting module 34, and a processing module 35 of the controlling system 10 can be hardware or firmware.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for playing back sound data applied in an electronic device, the electronic device comprising a storage device, the method comprising:
setting a first trigger condition for starting a recording function of the electronic device;
starting the recording function of the electronic device to record sound on detecting the first trigger condition;
storing the recorded sound as data in the storage device; and
extracting the stored sound data pertaining to a predetermined time period from the storage device on detecting a predetermined operation.

2. The method according to claim 1, further comprising:
stopping the recording function of the electronic device on detecting a second trigger condition; and
storing the extracted sound data into the storage device or deleting the extracted sound data.

3. The method according to claim 1, further comprising:
deleting the recorded sound data from the storage device when not detecting the predetermined operation in a predetermined time duration.

4. The method according to claim 1, wherein the first trigger condition comprises:
establishing a conversation connection, turning on a music playback function, turning on a broadcast function, receiving a predetermined word or phrase, or opening a predetermined application of the electronic device.

5. The method according to claim 2, wherein the second trigger condition comprises:
disconnecting a conversation connection, turning off a music playback function, turning off a broadcast function, closing a predetermined application of the electronic device, or not receiving a predetermined word or phrase during a predetermined duration.

6. The method according to claim 3, wherein the predetermined operation comprises:
pressing a physical button of the electronic device, clicking a virtual button of the electronic device, activating a touch screen of the electronic device, or shaking the electronic device.

7. An electronic device comprising:
a storage device;
at least one processor; and
the storage device further stores one or more programs that, when executed by the at least one processor, cause the at least one processor to:
set a first trigger condition for starting a recording function of the electronic device;
start the recording function of the electronic device to record sound on detecting the first trigger condition;
store the recorded sound as data in the storage device; and
extract the stored sound data pertaining to a predetermined time period from the storage device on detecting a predetermined operation.

8. The electronic device according to claim 7, wherein the at least one processor further caused to:
stop the recording function of the electronic device on detecting a second trigger condition; and
store the extracted sound data into the storage device or deleting the extracted sound data.

9. The electronic device according to claim 7, wherein the at least one processor further caused to:
delete the recorded sound data from the storage device when not detecting the predetermined operation in a predetermined time duration.

10. The electronic device according to claim 7, wherein the first trigger condition comprises:
establishing a conversation connection, turning on a music playback function, turning on a broadcast function, receiving a predetermined word or phrase, or opening a predetermined application of the electronic device.

11. The electronic device according to claim 8, wherein the second trigger condition comprises:
disconnecting a conversation connection, turning off a music playback function, turning off a broadcast function, closing a predetermined application of the electronic device, or not receiving a predetermined word or phrase during a predetermined duration.

12. The electronic device according to claim 9, wherein the predetermined operation comprises:
pressing a physical button of the electronic device, clicking a virtual button of the electronic device, activating a touch screen of the electronic device, or shaking the electronic device.

13. A non-transitory storage medium having stored thereon instructions that, when executed by a processor of an electronic device, causes the processor to perform a method for playing back sound data, the electronic device comprising a storage device, wherein the method comprises:
setting a first trigger condition for starting a recording function of the electronic device;
starting the recording function of the electronic device to record sound on detecting the first trigger condition;
storing the recorded sound as data in the storage device; and
extracting the stored sound data pertaining to a predetermined time period from the storage device on detecting a predetermined operation.

14. The non-transitory storage medium according to claim 13, further comprising:
stopping the recording function of the electronic device on detecting a second trigger condition; and
storing the extracted sound data into the storage device or deleting the extracted sound data.

15. The non-transitory storage medium according to claim 13, further comprising:
deleting the recorded sound data from the storage device when not detecting the predetermined operation in a predetermined time duration.

16. The non-transitory storage medium according to claim 13, wherein the first trigger condition comprises:
establishing a conversation connection, turning on a music playback function, turning on a broadcast function, receiving a predetermined word or phrase, or opening a predetermined application of the electronic device.

17. The non-transitory storage medium according to claim 14, wherein the second trigger condition comprises:
disconnecting a conversation connection, turning off a music playback function, turning off a broadcast function, closing a predetermined application of the electronic device, or not receiving a predetermined word or phrase during a predetermined duration.

18. The non-transitory storage medium according to claim 15, wherein the predetermined operation comprises:
pressing a physical button of the electronic device, clicking a virtual button of the electronic device, activating a touch screen of the electronic device, or shaking the electronic device.
